(19) United States
(12) Patent Application Publication
(10) Pub. No.: US 2009/0090449 A1
(43) Pub. Date: Apr. 9, 2009

(54) PNEUMATIC TIRE

(76) Inventors: Jean-Bernard Bodeux, Bastogne (BE); Jean-Marie Feller, Messancy (BE); Richard William Scavuzzo, Wadsworth, OH (US); Dany Assaker, Arlon (BE); Denis Gerard, Arlon (BE); Laurent Licht, Zoufftgen (FR); Didier Winkin, Bastogne (BE); Felix Maximo Vilchez Marcuri, Colmar-Berg (LU); Wolfgang Karl Maegerle, Erlensee (DE)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 12/243,373

(22) Filed: Oct. 1, 2008

Related U.S. Application Data
(60) Provisional application No. 60/977,382, filed on Oct. 4, 2007.

(51) Int. Cl. B60C 15/06

(52) U.S. Cl. 152/541

(57) ABSTRACT

A pneumatic radial tire, the tire comprising at least one carcass reinforcing ply and a pair of opposing bead portions. Each bead portion has a bead core and a bead apex, and the at least one carcass reinforcing ply has a down portion located axially inward of the bead and a turnup end located axially outward of the bead core. The turnup end of the ply is about parallel to the down portion.

This application claims the benefit of, and incorporates by reference, U.S. Provisional Application No. 60/977,382 filed Oct. 4, 2007.

### FIELD OF THE INVENTION

The present invention is directed to a pneumatic tire. More specifically, the present invention is directed to a pneumatic radial tire wherein the bead portion of the tire is designed for improved durability due to the configuration of the turn-up portion of the carcass reinforcing ply.

### BACKGROUND OF THE INVENTION

Bead area durability is one of the main concerns of the tire industry, more typically when the tire is overloaded or the temperatures and other conditions such as speed are extreme. A conventional tire bead portion 100 is illustrated in FIG. 6. What is conventionally considered the main portion 104 of a carcass reinforcing ply extends radially inward toward the tire rim and is turned about an inextensible bead core 106 to form a carcass ply turnup 108. The carcass ply turnup 108 extends at a single angle μ relative to a radial line tangent to the axially outermost point of the bead core 106 and parallel to the tire equatorial plane.

Due to the configuration and nature of the radial carcass, when a tire is expanded, the main portion of the carcass is put under tension, pulling the carcass main portion 104 radially upward and the carcass turnup 108 radially inward. After inflation and during operation of the tire, when the tire is under deflection, the carcass ply is subject to bending forces and the carcass main portion 104 moves radially inward while the carcass turnup 108 moves radially and axially outward. During both tension and deflection, the rubber surrounding the carcass main portion 104 and the carcass turnup 108, due to the adhesion relationship between the rubber and the reinforcing cords of the ply, also is forced to move and the rubber is stressed. The movement of the carcass ply and the surrounding rubber may result in cracking of the rubber in the tire bead portion, decreasing durability of the tire.

### SUMMARY OF THE INVENTION

The invention provides in a first aspect a pneumatic radial tire, the tire comprising at least one carcass reinforcing ply and a pair of opposing bead portions, each bead portion has a bead core and a bead apex, the at least one carcass reinforcing ply has a down portion located axially inward of the bead and a turnup end located axially outward of the bead core, wherein the turnup end of the ply is about parallel to the down portion.

The invention provides in a second aspect a pneumatic radial tire, the tire comprising at least one carcass reinforcing ply and a pair of opposing bead portions, each bead portion has a bead core and a bead apex, the at least one carcass reinforcing ply has a down portion located axially inward of the bead and a turnup end located axially outward of the bead core, wherein the turnup end of the ply is not parallel to the down portion, and wherein the lines of the turnup end and the down portion are divergent with respect to each other.

### BRIEF DESCRIPTION OF THE DRAWINGS

The invention will be described by way of example and with reference to the accompanying drawings in which:

FIG. 1 is a cross-sectional view of half of a pneumatic tire;

FIG. 2 is a close up of the bead portion that represents the control or reference configuration;

FIGS. 3-4 are alternative bead portion constructions of the invention;

FIG. 5 is a cross-sectional view of an optional tread configuration; and

FIG. 6 is a prior art bead configuration.

### DEFINITIONS

“Aspect Ratio” means the ratio of a tire's section height to its section width.

“Axial” and “axially” mean the lines or directions that are parallel to the axis of rotation of the tire.

“Bead” or “Bead Core” means generally that part of the tire comprising an annular tensile member, the radially inner beads are associated with holding the tire to the rim being wrapped by ply cords and shaped, with or without other reinforcement elements such as flippers, chippers, apexes or fillers, toe guards and chafers.

“Belt Structure” or “Reinforcing Belts” means at least two annular layers or plies of parallel cords, woven or unwoven, underlying the tread, unanchored to the bead, and having both left and right cord angles in the range from 17° to 27° with respect to the equatorial plane of the tire.

“Bias Ply Tire” means that the reinforcing cords in the carcass ply extend diagonally across the tire from bead-to-bead at about 25-65° angle with respect to the equatorial plane of the tire, the ply cords running at opposite angles in alternate layers

“Block element” means a tread element defined by a circumferential groove or shoulder and a pair of laterally extending grooves.

“Breakers” or “Tire Breakers” means the same as belt or belt structure or reinforcement belts.

“Carcass” means a laminate of tire ply material and other tire components cut to length suitable for splicing, or already spliced, into a cylindrical or toroidal shape. Additional components may be added to the carcass prior to its being vulcanized to create the molded tire.

“Circumferential” means lines or directions extending along the perimeter of the surface of the annular tread perpendicular to the axial direction; it can also refer to the direction of the sets of adjacent circular curves whose radii define the axial curvature of the tread as viewed in cross section.

“Cord” means one of the reinforcement strands, including fibers, which are used to reinforce the plies.

“Inner Liner” means the layer or layers of elastomer or other material that form the inside surface of a tubeless tire and that contain the inflating fluid within the tire.

“Inserts” means the reinforcement typically used to reinforce the sidewalls of runflat-type tires; it also refers to the elastomeric insert that underlies the tread.

“Ply” means a cord-reinforced layer of elastomer-coated, radially deployed or otherwise parallel cords.

“Radial” and “radially” mean directions radially toward or away from the axis of rotation of the tire.

“Radial Ply Structure” means the one or more carcass plies or which at least one ply has reinforcing cords oriented at an angle of between 65° and 90° with respect to the equatorial plane of the tire.

“Rib” means a circumferentially extending strip of rubber of the tread which is defined by at least one circumferential groove and either a second circumferential groove or a lateral edge, wherein the strip is not divided by full depth grooves.

“Radial Ply Tire” means a belted or circumferentially-restricted pneumatic tire in which the ply cords which extend from bead to bead are laid at cord angles between 65° and 90° with respect to the equatorial plane of the tire.

“Sidewall” means a portion of a tire between the tread and the bead.

“Laminate structure” means an unvulcanized structure made of one or more layers of tire or elastomer components such as the innerliner, sidewalls, and optional ply layer.

### DETAILED DESCRIPTION OF THE INVENTION

The following language is of the best presently contemplated mode or modes of carrying out the invention. This description is made for the purpose of illustrating the general principles of the invention and should not be taken in a limiting sense. The scope of the invention is best determined by reference to the appended claims. The reference numerals as depicted in the drawings are the same as those referred to in the specification. For purposes of this application, the various embodiments illustrated in the figures each use the same reference numeral for similar components. The structures employ basically the same components with variations in location or quantity thereby giving rise to the alternative constructions in which the inventive concept can be practiced.

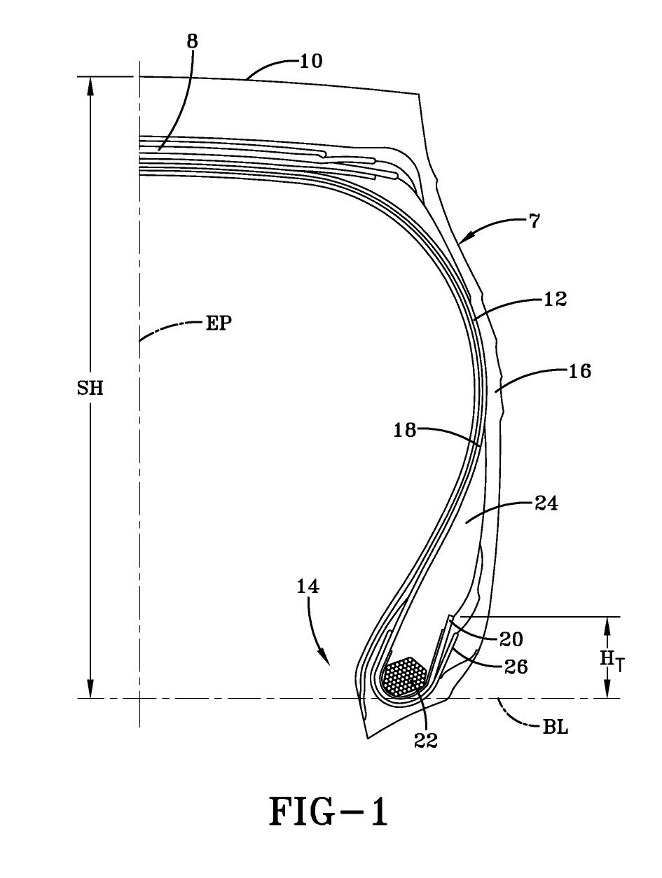

A first embodiment of a pneumatic tire is shown in FIG. 1, which has a carcass 7, a belt structure 8 radially outward of the carcass, and a tread 10 radially outward of the belt structure 8. The belt structure 8 may be any of the type conventionally used for a pneumatic tire, and generally will include at least two reinforcement plies of angled, inclined cords and may include a ply of zero degree cords. The actual belt structure of the tire will be dictated by the intended end use of the tire. Similarly, the exact tread configuration will be dictated by the intended end use of the tire.

The carcass may have only one carcass reinforcement ply 12, or one or more carcass reinforcing plys 12, a pair of opposing bead portions 14 and a pair of opposing sidewalls 16. The ply 12 has a main portion 18 extending through the opposing sidewalls 16 and a carcass turnup 20 initiating in the bead portions 14. The carcass turnup 20 of the carcass reinforcing ply 12 extends from the main portion 18 of the carcass reinforcing ply 12, and is wrapped about a bead core 22 and a bead apex 24 in the bead portion 14. The carcass turnup 20 terminates at a distance H_{T} from the tire bead base line BL. The tire bead base line BL is an imaginary line, perpendicular to the equatorial plane EP of the tire, from the intersection of the radially extending outerside of the bead portion and the bead base of the tire.

Outward of the carcass ply 12 in the bead portion 14 is a cord reinforced ply, referred to as the chipper 26. The chipper 26 extends from axially inward of the bead core 22 to axially outward of the bead core 22, being turned up around the bead core 22 similar to the carcass ply 12. The axially outer end 26b of the chipper preferably terminates radially inward of the carcass ply end 20. The chipper 26 is optional and may be omitted from the tire construction so that the only reinforcing cord ply that wraps about the bead core 22 is the carcass ply 12.

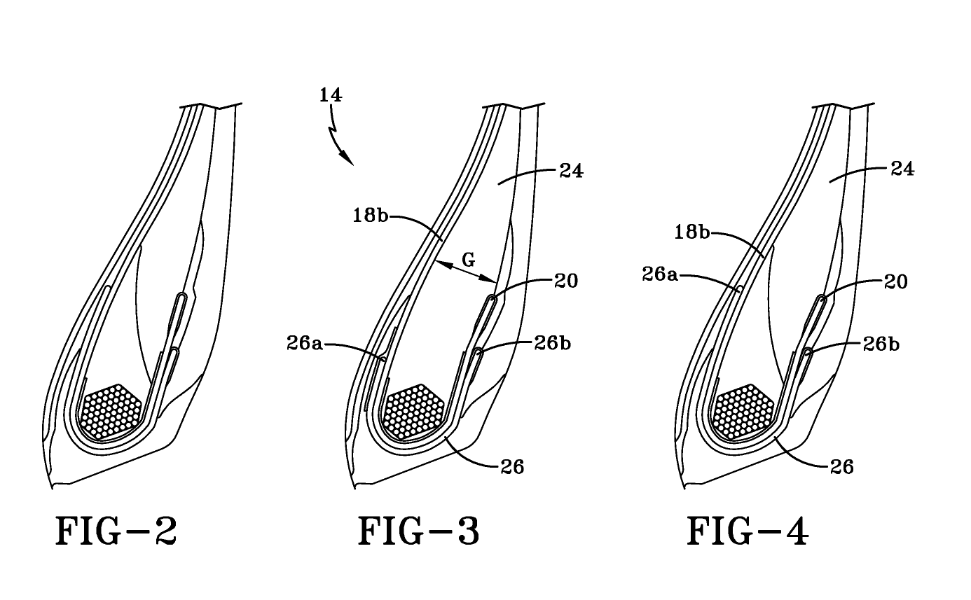

FIG. 2 illustrates a control or reference configuration of a bead configuration. FIG. 3 represents a first embodiment of the invention. FIG. 3 illustrates a robust bead configuration. First, the gauge G of the apex 24 was increased relative to the control in order to lower shear stress cycles and temperature, preferably in the range of 1-5 mm, more preferably about 2-4 mm. Secondly, it is preferred that a single, soft apex be utilized for improved durability. Optionally, the apex volume may also be decreased in the range of about 5-15% for improved durability. Preferably, the ply turnup end 20 and chipper end 26b was rotated away from the apex in the range of about 5 to 15 degrees, preferably 5-10 degrees. More preferably, the ply turnup end 20 and chipper end 26b are oriented about parallel to the down ply 18b. The curvature of the ply turnup/chipper end may be curved in a parallel manner to down ply as shown in FIG. 4, or may be linear as shown in FIG. 3. However, the ply turnup and chipper need not be exactly parallel, and the ply turnup and chipper may be rotated about 5 degrees axially outward from the parallel configuration.

Optionally, the inside chipper end 26a was moved radially inward in the range of about 5 to 15 mm relative to the control tire, so that the inside chipper end 26a is radially inward of outside chipper end 26b. Optionally the inside chipper end 26a may be at about the same radial distance from the bead as the outer chipper end 26b, or slighter radially outwards of the end 26b, as shown in FIG. 4. FIG. 4 also illustrates a dual compound apex which may be utilized.

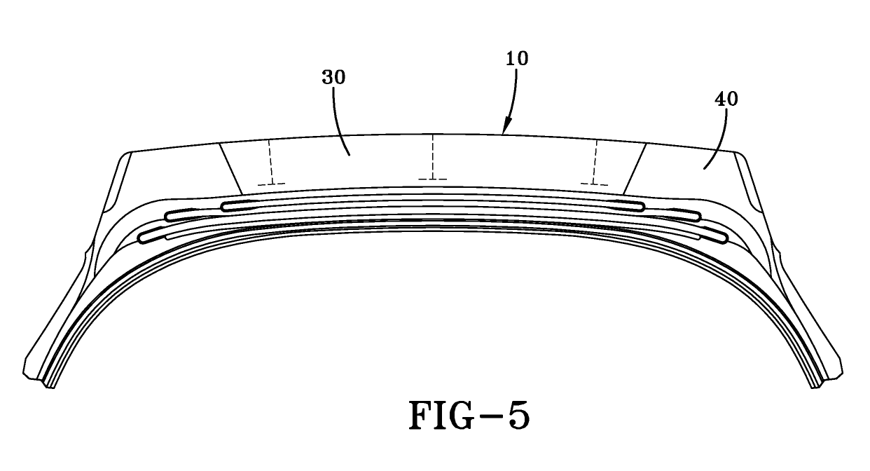

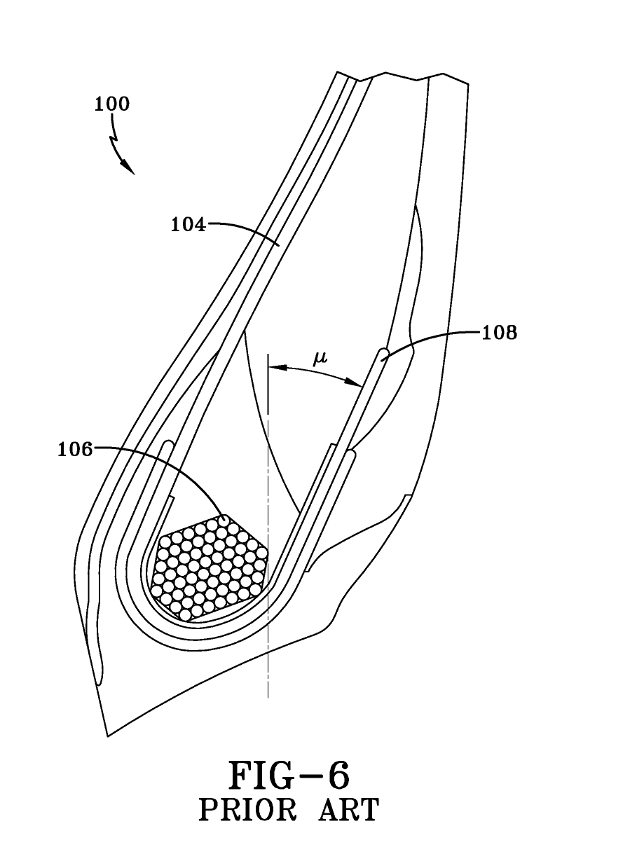

To further improve the durability of the tire, the tread 10 may be configured as shown in FIG. 5. FIG. 5 illustrates a tread divided into a center zone 30 and outer shoulder zones 40. The center zone may be formed of a compound that has a lower running temperature under load, while the outer shoulder zones 40 may be selected for high durability.

The tire of the present invention has an improved life and improved bead durability. The teachings herein are applicable to a broad range of tires and may be useful in tire lines such as, but not limited to, passenger tires, radial medium truck tires, aircraft tires, and off-the-road tires. The teachings may also be useful in improving bead durability for run-flat tires of any type.

What is claimed is:

1. A pneumatic radial tire, the tire comprising at least one carcass reinforcing ply and a pair of opposing bead portions, each bead portion has a bead core and a bead apex, the at least one carcass reinforcing ply has a down portion located axially inward of the bead and a turnup end located axially outward of the bead core, wherein the turnup end of the ply is about parallel to the down portion.

2. The tire of claim 1 further comprising a chipper having an axially inner end and an axially outer end, wherein the axially inner end is located radially inward of the ply turnup end.

3. The tire of claim 1 further comprising a chipper having an axially inner end and an axially outer end, wherein the axially inner end is located radially inward of the axially outer end.

4. The tire of claim 1 wherein ply turnup end has the same curvature as the downply.

5. The tire of claim 1 wherein the apex is formed of one compound.

6. The tire of claim 1 wherein the apex has a gauge in the range of about 2 to about 5 mm.

7. The tire of claim 1 further comprising a tread having an inner zone formed of a first compound and outer shoulder zones formed of a second compound.
